(19) United States
(12) Patent Application Publication
(10) Pub. No.: US 2003/0042100 A1
(43) Pub. Date: Mar. 6, 2003

(54) Freewheel hub device

(76) Inventor: Shu-Chen Juan, Taipei (TW)

Correspondence Address: Shu-Chen Juan, 235 Chung-Ho, Box 8-24, Taipei, TW

(21) Appl. No.: 10/059,387

(22) Filed: Jan. 31, 2002

(30) Foreign Application Priority Data
Aug. 28, 2001 (TW) 090214883

(51) Int. Cl. F16D 41/30

(52) U.S. Cl. 192/64; 192/46; 301/110.5

(57) ABSTRACT

A freewheel hub device comprises a spindle. A hub, a ratchet, a freewheel, an annular cover, and a sealing washer are sequentially arranged along the spindle. A flange extends from the freewheel at a position with respect to the inner lateral side of the hub. A ball ring encloses the flange so as to position the ratchet. The recess is installed at another end of the hub. An inner periphery of the recess is installed with a plurality of retaining grooves and first texture recesses. An inner side of the recess is arranged with a ratchet ring. The flange extending from the freewheel is engaged with a positioning ratchet pawl. The ratchet ring is installed with a groove. After the ball ring and ratchet are engaged with the flange. The flange and the ratchet ring are installed in the recess of the hub.

### BACKGROUND OF THE INVENTION

1) Field of the Invention

The present invention relates to freewheel hub devices, the rotation of the freewheel hub is improved and strength of the spindle is enhanced so that it is difficult to deform the hub.

2) Description of the Prior Art

A conventional freewheel hub device, referring to FIG. 1 and FIG. 2, is typically comprised of a spindle 2. Moreover, a hub 3, a ratchet 4, a freewheel 5, an annular cover 6, and a sealing washer 7 are sequentially arranged along the spindle.

The hub 3 has a groove 31 in one end for installing a bearing 32. A fastening component 33 is installed at an outer portion to secure the bearing 32 in position. A recess 34 is disposed in the other end. A threaded section 341 is formed on the inner periphery of the recess 34 for fastening a ratchet ring 35. A groove 342 is formed at the lower wall of the recess 34 for installing a bearing 36.

One end of the ratchet 4 has a threaded section 41 and another end thereof is an enlarged end. An outer end of the enlarged end is installed with plurality of ratchet pawls 42 which can move upwards and downwards. for engaging the ratchet 351 in the ratchet wheel 35.

The freewheel 5 has a groove 51 aligned with the end portion of the ratchet mechanism 4. A threaded section 52 is formed at an inner side thereof, enabling the fastening of the threaded section 41 of the ratchet 4 into the threaded section 52 until the ratchet mechanism 4 is tightened and stopped against the lower wall of the of the groove 51. The freewheel 5 has a groove 53 formed at another end of the freewheel such that two bearings 54 and 55 are formed with a groove 53. A fastening component 56 serves to fix the bearing components in position.

The annular cover 6 and the sealing washer 7 are installed in the end opening of the hub 3.

The above structure enables the conventional freewheel hub to rotate smoothly.

In the structure, bearings 31, 36, 54 and 55 cause the freewheel hub to rotate smoothly. Since the bearings 31 and 35 are situated at the two interior ends of the hub 3 and the bearings 54 and 55 are situated in the groove 53 at another end of the freewheel 5. Thereby, in application, smooth rotation is effectively achieved. However, after the completed freewheel hub and cogs (not shown) is installed on a bicycle, one end of the freewheel 5 with respect to the hub 3 is screwedly fastened to the ratchet 4 and finally is engaged to the hub 3. But since the engagement is a prior art way, in the engaging place, the whole hub 3 is assembled to a bicycle. A position between the freewheel 5 and the hub 3 suffering from a largest force is easily formed with a gap as the bicycle moves. Thereby, the spindle 3 will bend so that the whole hub 3 can not operate smoothly.

### SUMMARY OF THE INVENTION

Therefore, the primary objective of the present invention is to provide a freewheel hub device having a spindle, further a hub, a ratchet, a freewheel, an annular cover, and a sealing washer being sequentially arranged along the spindle.

One lateral side of the hub has a first groove for installing a first ball ring, wherein the first ball ring is a ring with a plurality of balls disposed on the ring. A first guide ring is installed at an outer portion for securing the first ball ring in position. A first recess is disposed in the other end;

The ratchet consists of a plurality of first pawls which are capable of moving upwards and downwards.

The freewheel has a second groove formed at a position with respect to an inner side of the ratchet for installing a ball ring, wherein the ball ring is a ring with a plurality of balls disposed on the ring. A second guide ring serves for securing the second ball ring in position.

The annular cover and the sealing washer are installed at an opening of the hub.

A flange extends from the freewheel at a position corresponding to an inner lateral side of the hub. A third ball ring with a plurality of balls installed on the ring encloses an outer side of the flange so as to position the ratchet. The recess is installed at another end of the hub. An inner periphery of the recess is installed with a plurality of retaining grooves and first texture recesses. An inner side of the recess is arranged with a ratchet ring. The ratchet ring has a plurality of matching ridges and second texture recesses at an outer circumference which are engaged with the plurality of retaining grooves and first texture recesses on the inner periphery of the recess; a hollow center of the ratchet ring is formed as a third groove. The flange extending from the freewheel at the position corresponding to the inner lateral side of the hub is engaged with a ratchet pawl and the third ball ring. The ratchet ring is engaged with the third groove. After the third ball ring and ratchet are engaged with the flange at a front end of the freewheel, the flange at the front end of the freewheel and the ratchet ring are installed in the recess of the hub.

Thereby, the cost for bearings is reduced and moreover, the weight is decreased. As a result, in practical operation, the hub rotates smoothly and the strength of the spindle is increased so that it is difficult to deform the spindle.

To enable a further understanding of the structural features and other operational details of the present invention, the brief description of the drawings below is followed by the detailed description of the invention.

### BRIEF DESCRIPTION OF THE DRAWINGS

FIG. 1 is an exploded view of a conventional freewheel hub device.

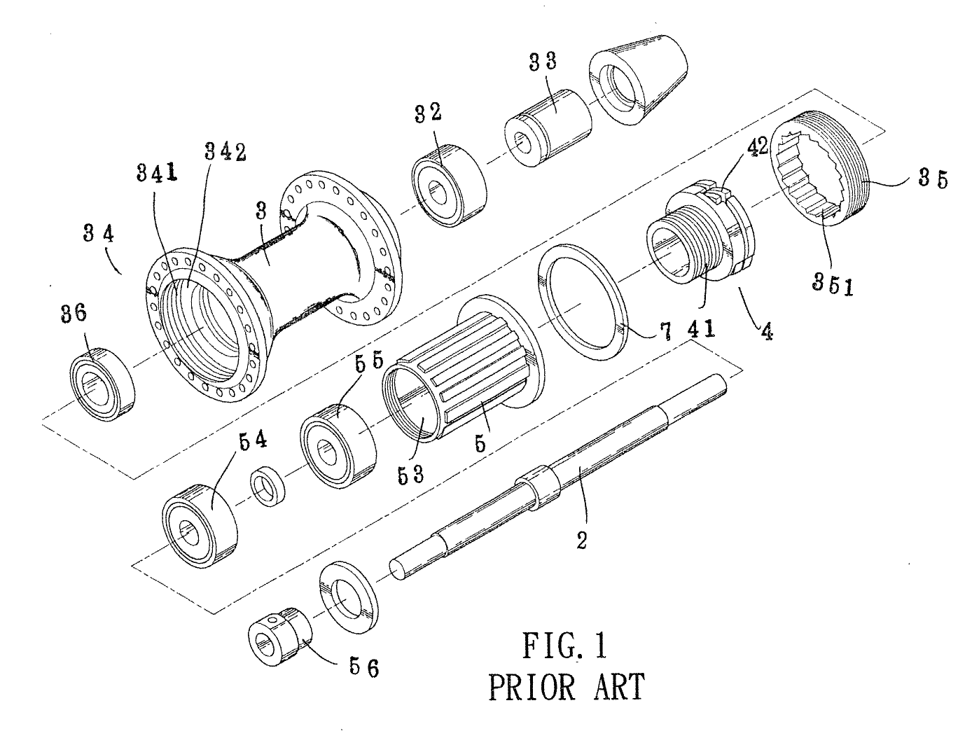

FIG. 2 is a cross-sectional view of the conventional freewheel hub device.

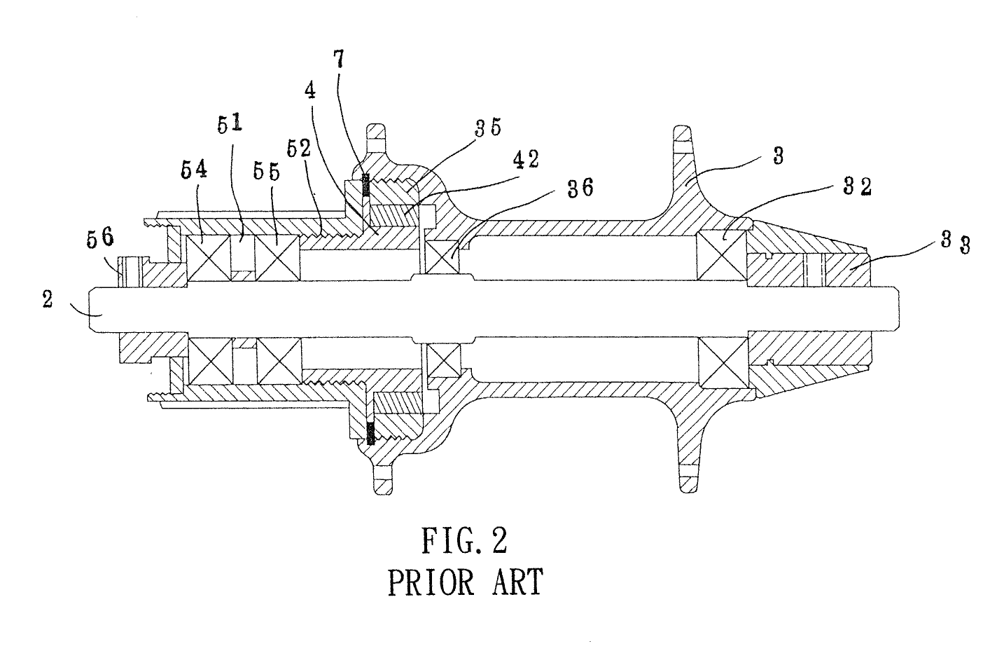

FIG. 3 is an exploded view of the freewheel hub device of the present invention.

FIG. 4 is a cross-sectional view of the freewheel hub device of the present invention.

FIG. 5 is a schematic view of the feeewheel hub device of another embodiment of the present invention.

FIG. 6 is a schematic view of the feeewheel hub device of another embodiment of the present invention.

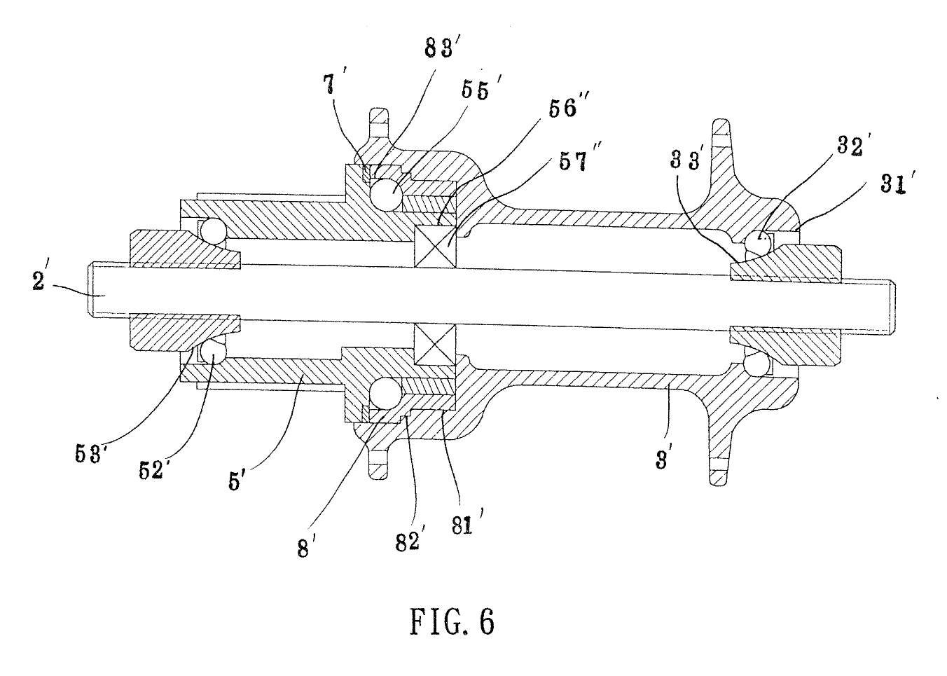

### DETAILED DESCRIPTION OF THE INVENTION

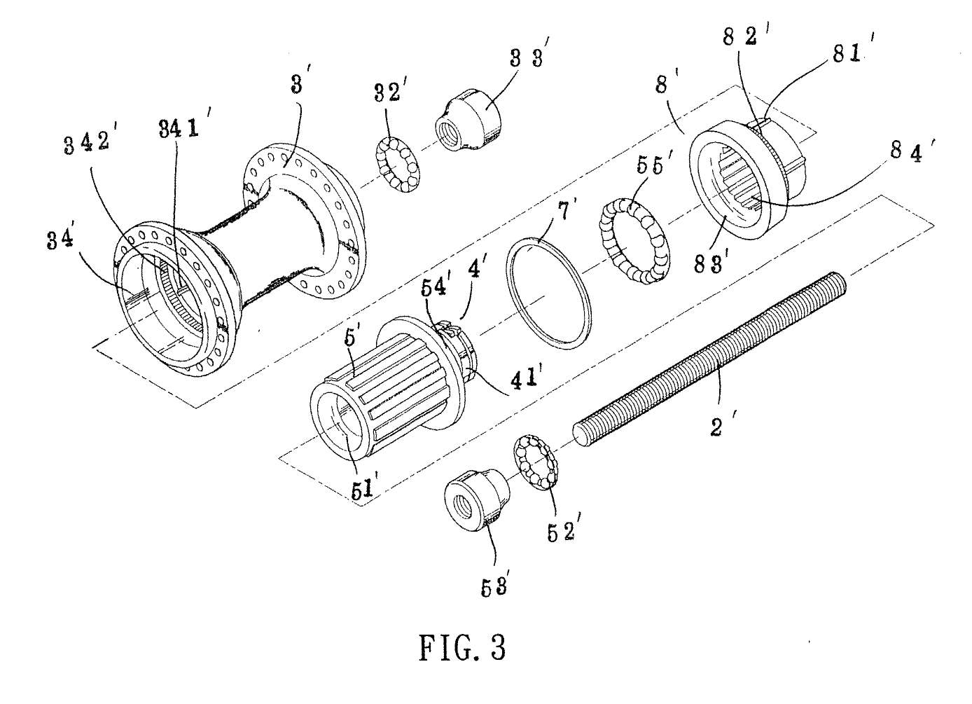

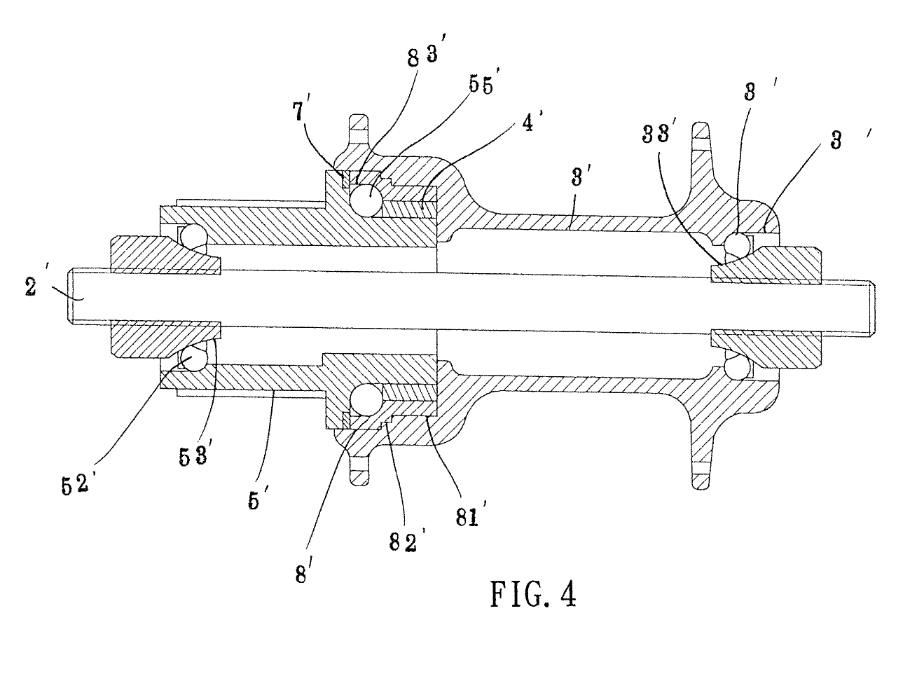

Referring to FIG. 3 and FIG. 4, the bicycle freewheel hub device of the present invention comprises a spindle 2′. Furthermore, a hub 3′, a ratchet 4′, a freewheel 5′, an annular cover 6′, and a sealing washer 7′ are sequentially arranged along the spindle 2′.

One lateral side of the hub 3′ has a groove 31′ for installing a bearing 32′. A guide ring 33′ is installed at an outer portion for securing a ball ring 32′ in position, wherein the ball ring has a plurality of balls thereon and the ball may be steel ball, and the ball ring may be replaced by a pin ring (a ring installed with a plurality of pin thereon). A recess 34′ is disposed in the other end.

The ratchet 4′ consists of a plurality of pawls 41′ which can move upwards and downwards.

The freewheel 5′ has a cambered trench 51′ formed at a position with respect to the inner side of another side of the ratchet 4′ for installing a ball ring 52′. A guide ring 53′ serve for securing a ball ring 54′ in position.

The annular cover 6′ and the sealing washer 7′ are installed at the opening of the hub 3′.

The feature of the present invention is that a flange 54′ extends from the freewheel 5′ at a position corresponding to the inner lateral side of the hub 3′. The ball ring 55′ encloses the surface of the outer side of the flange 54′ so as to position the ratchet 4′. A recess 34′ is installed at another end of the hub 3′. The inner periphery of the recess is installed with a plurality of retaining grooves 341′ and textured grooves 342′. The inner side of the recess 34′ is arranged with a ratchet ring 8′. The ratchet ring 8′ has a plurality of matching ridges 81′ and textured grooves 82′ at the outer circumference thereof which are engaged with the retaining grooves and texture recesses of the recess. The ratchet ring 8′ has a ratchet groove 84 at the center of the ring. The flange 54′ extending from the freewheel 5′ at the position with respect to the inner lateral side of the hub 3′ is engaged with a positioning ratchet pawl 41′. The pawl 41′ is engaged with the ball ring 55′ and the ratchet groove 84′. After the bearing 58′ and ratchet 4′ are engaged with the flange 54′ at a front end of the freewheel 5′, the flange 54′ at the front end of the freewheel 5′ and the ratchet ring 8′ can be installed in the recess 34′ at one end of the hub 3′.

After above components are assembled, the freewheel-type hub with cogs (not shown) are installed on a bicycle. Since the interior section of the freewheel 5′ extending beyond the flange 54′ and aligned with the hub 3′ serves for installing the sealing washer 7′ and the bearing 58′ as well as the insertion of the ratchet 4′ and the ball bearing 55′, it is further coupled with the guide ring 83 and the ratchet groove 84′ with the ratchet ring 8′. Furthermore, the flange 54′ of the freewheel 5′ and the ratchet ring 8′ can be placed in the recess 34′ of the hub 3′. This enables the freewheel 5′, the ratchet ring 8′, and the hub 3′ are combined into a single structure for suffering the maximum stress at the connection of the freewheel 5′ and the hub 3′. Furthermore, by the flange 54′ of the freewheel 5, the ball ring 55′ and the guide ring 83′ on the ratchet ring 8′, the guide ring 33′ serves to position the ball ring 32′ in the cambered groove 31′, and the ball ring 52′ in the cambered trench 51′ is positioned in the guide ring 53′. Therefore, the whole structure may rotate. Furthermore, the present invention can replace the prior art bearing which is formed by an inner cover and an outer cover with balls being installed therebetween. The bearings 55 or 36 of the prior art structure are not used in the present invention. Therefore, the cost for bearings is reduced and moreover, the weight is decreased. . Therefore, in practical operation, the hub can rotate smoothly and the strength of the spindle is increased so that it is difficult to deform the spindle.

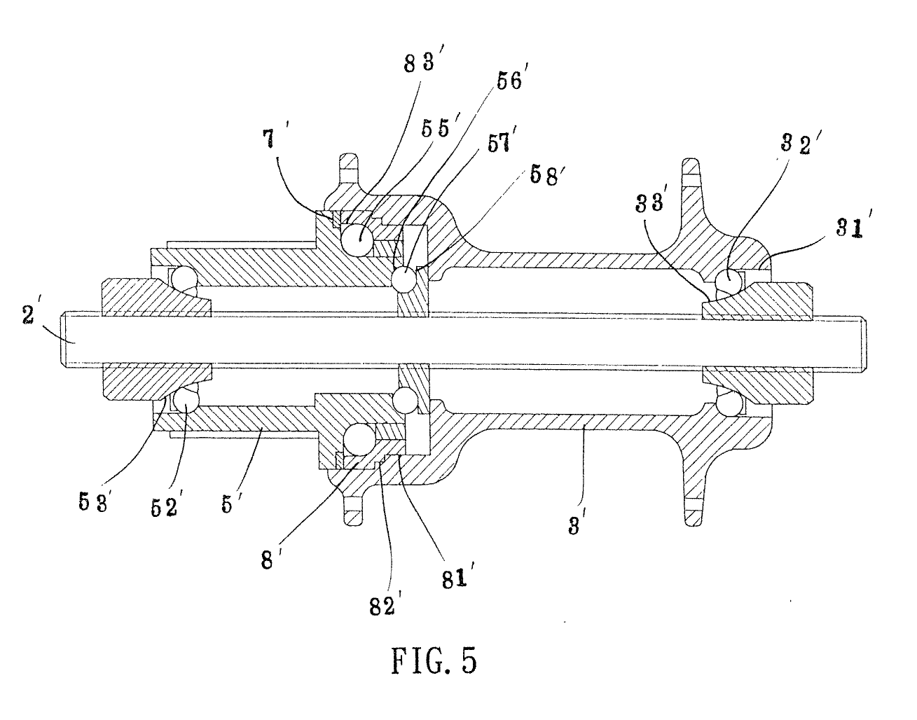

Referring to FIG. 5, a groove 56′ is formed in the freewheel 5′ at a position with respect to the flange 54′ extended from the inner side of the hub 3′. A ball ring 54′ is engaged therewith. Furthermore, a groove 56′ can be installed in the flange 54′. Thereby, a rolling-pin type or a ball ring 57′ can be positioned therein. Therefore, in practical operation, the hub can rotate smoothly and the strength of the spindle is increased so that it is difficult to deform the spindle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A freewheel hub device having a spindle, further a hub, a ratchet, a freewheel, an annular cover, and a sealing washer being sequentially arranged along the spindle; wherein
one lateral side of the hub has a first groove for installing a first ball ring, wherein the first ball ring is a ring with a plurality of balls disposed on the ring; a first guide ring is installed at an outer portion for securing the first ball ring in position; a first recess is disposed in the other end;
the ratchet consists of a plurality of first pawls which is capable of moving upwards and downwards;
the freewheel has a second groove formed at a position with respect to an inner side of the ratchet for installing a ball ring, wherein the ball ring is a ring with a plurality of balls disposed on the ring; a second guide ring serves for securing the second ball ring in position;
the annular cover and the sealing washer are installed at an opening of the hub;
wherein a flange extends from the freewheel at a position corresponding to an inner lateral side of the hub; a third ball ring with a plurality of balls installed on the ring encloses an outer side of the flange so as to position the ratchet, the recess is installed at another end of the hub; an inner periphery of the recess is installed with a plurality of retaining grooves and first texture recesses; an inner side of the recess is arranged with a ratchet ring; the ratchet ring has a plurality of matching ridges and second texture recesses at an outer circumference which are engaged with the plurality of retaining grooves and first texture recesses on the inner periphery of the recess; a hollow center of the ratchet ring is formed as a third groove; the flange extending from the freewheel at the position corresponding to the inner lateral side of the hub is engaged with a ratchet pawl and the third ball ring; the ratchet ring is engaged with the third groove; after the third ball ring and ratchet are engaged with the flange at a front end of the freewheel; the flange at the front end of the freewheel and the ratchet ring are installed in the recess of the hub;
thereby, the cost is reduced and moreover, the weight is decreased; as a result, in practical operation, the hub rotates smoothly and the strength of the spindle is increased so that it is difficult to deform the spindle.

2. The freewheel hub device of claim 1, wherein the balls on the ball ring are steel balls.

3. The freewheel hub device of claim 1, wherein a fourth groove is formed in the freewheel at a position with respect to the flange extended from the inner side of the hub; a fourth ball ring is engaged therewith; furthermore, a groove is installed in the flange; thereby, the fourth ball ring is positioned therein; therefore, in practical operation, the hub rotates smoothly and the strength of the spindle is increased so that it is difficult to deform the spindle.
